(19) United States
(12) Patent Application Publication
(10) Pub. No.: US 2012/0082501 A1
(43) Pub. Date: Apr. 5, 2012

(54) Transport arrangement for printing materials in a printing machine

(76) Inventor: Dimitrios Kostudis, Wedel (DE)

(21) Appl. No.: 13/200,669

(22) Filed: Sep. 28, 2011

(30) Foreign Application Priority Data
Sep. 29, 2010 (DE) 102010046962.9

(51) Int. Cl. B41J 11/04

(52) U.S. Cl. 400/611

(57) ABSTRACT

In a transport arrangement for printing materials in a printing machine, said transport arrangement comprising one rotatably supported first transport roller with a first shaft and a roller body having a first outside diameter and comprising at least one rotatably supported second transport roller with a second shaft and a roller body having a second outside diameter, said second transport roller when viewed in transport direction of the printing material arranged downstream of the first transport roller, a actuating arrangement is provided for the adjustment of the outside diameter of the first or the second transport rollers or both. The actuating arrangement allows the adjustment of the outside diameter in such a manner that the outside diameters of the first or of the second transport rollers or both are at a fixed ratio relative to each other.

### FIELD OF THE INVENTION

The present invention relates to a transport arrangement for printing materials in a printing machine as well as to a method for calibrating such a transport arrangement.

### BACKGROUND OF THE INVENTION

In printing machines or similar machines for processing printing materials, a printing material is transported from a supply roll or a stack of sheets in a feeder unit through a printing or processing section to a delivery unit where the completely processed printing materials are deposited. While the printing material is processed in the printing machine, said material mostly moves over a plurality of transport rollers or transport belts or both which are successively arranged in transport direction. During that movement, the sheet or the web of printing material is mostly in engagement with several transport rollers. Therefore, the transport rollers should move as synchronously as possible because, otherwise, the printing material can be damaged, an imprecise printed image or other positioning errors or both can occur. For example, in multi-color printing, there is the problem that not all the colors are precisely superimposed (registration error). In the same way, it can happen that the printing material does not move precisely into a cutting device.

Consequently, the successively arranged transport rollers in such a printing machine should transport all the printing materials at the same speed when a printing material web is transported or when sheets are transported at equal relative distances. Alternatively, the individual transport rollers have to maintain an exact ratio of speeds relative to each other if they have different speeds that are adapted to each other, for example, in order to convey sheets at increasing or decreasing distances from each other.

For example, it is possible to achieve such an identical transport speed or such an identical ratio of transport speeds of the successively arranged transport rollers in that several transport rollers are driven by the same driving motor. Here, the transport rollers are connected, for example, by arrangement of toothed gears or a driving belt and have exactly the same outside diameters. The transport rollers for such a transport arrangement comprising a common drive therefore have to maintain highly exact tolerances, so that said transport rollers have exactly the same outside diameters and thus drive a printing material at the same transport speed with the same input rate of revolutions.

If, alternatively, transport rollers are used having been made with less narrow tolerances and thus displaying minimally different outside diameters, the input rate of revolutions has to be calibrated or controlled within narrow limits, so that the transport speed of a conveyed printing material will be the same for each transport roller, even if the outside diameters of the rollers are minimally different.

Narrow tolerances also apply to transport arrangements comprising successively arranged transport rollers having different transport speeds. This is to say that the different driving speeds be precisely maintained. In the same way, it would be possible to achieve exactly the same driving speed ratios in that the outside diameters of the transport rollers that are used are made at a fixed ratio. Alternatively, the input rates of revolution of the transport rollers would have to be kept at an exactly determined ratio.

The object of the present invention is to permit greater tolerances making transport rollers, to implement cost savings as a result of this and, optionally, to increase the flexibility of the transport process.

### SUMMARY OF THE INVENTION

In a transport arrangement for printing materials in a printing machine, said transport arrangement comprising one rotatably supported first transport roller with a first shaft and a roller body having a first outside diameter and comprising at least one rotatably supported second transport roller with a second shaft and a roller body having a second outside diameter, said second transport roller when viewed in transport direction of the printing material arranged downstream of the first transport roller, a actuating arrangement is provided for the adjustment of the outside diameter of the first or the second transport rollers or both. The actuating arrangement allows the adjustment of the outside diameter in such a manner that the outside diameters of the first or of the second transport rollers or both are at a fixed ratio relative to each other.

The object of the present invention is achieved with a transport arrangement for printing materials in a printing machine. In particular, the transport arrangement includes one rotatably supported first transport roller with a first shaft and a roller body having a first outside diameter at least one rotatably supported second transport roller with a second shaft and a roller body having a second diameter is arranged when viewed in transport direction of the printing material downstream of the first transport roller. Actuating arrangements for the adjustment of the outside diameter of the first or the second transport rollers or both are provided in such a manner that the outside diameters of the first or the second transport rollers or both are at a fixed ratio relative to each other. As a result of this, it is possible to compensate for variations of the transport speeds between different transport rollers, at which speeds the transport rollers transport the printing material. It is also possible to adjust desired speed differences for process-specific or other reasons (for example, temperature, humidity) in a controlled manner.

In one embodiment the fixed ratio is equal to 1. Thus, a plurality of transport rollers, said rollers successively arranged in transport direction of the printing material, can provide the same transport speed with the same input rate of revolutions and with deviating dimensions.

In one embodiment of the transport arrangement, the ratio is determined before the printing machine is operated. As a result of this, a simple calibration of the printing machine is performed.

In another embodiment the transport arrangement is actuated while at least one of the transport rollers is rotating. This results in a dynamic adjustability.

In a transport arrangement, wherein the transport rollers are driven by a common driving motor, this is beneficial as components and hence costs are saved and as the control of the drive is facilitated.

Depending on the embodiment of the transport arrangement, the actuating arrangement are pneumatically, hydraulically, mechanically or piezoelectrically driven or both. The pneumatic, hydraulic and piezoelectric driving modes are suitable for dynamic adjustments; the mechanical driving mode is cost-favorable.

Furthermore, the object of the present invention is achieved by a printing. The printing machine includes at least one printing unit and at least one transport arrangement.

In addition, the object of the present invention is achieved by a method for calibrating a transport arrangement for printing materials in a printing machine. The printing machine includes one first transport roller having a first outside diameter and at least one second transport roller having a second outside diameter. The method includes the step of adjusting the outside diameter of at least one of the second transport rollers to a dimension that is at a fixed ratio relative to the outside diameter of the first transport roller.

In one embodiment of the method, the fixed ratio is equal to 1. Thus, a plurality of transport rollers arranged successively in transport direction of the printing material can provide the same transport speed with the same input rate of revolutions and with different dimensions.

In one embodiment of the method, the ratio is fixed before the printing machine is operated. As a result of this, it is possible to perform a simple calibration of the printing machine.

In another embodiment of the method, the ratio is fixed while at least one transport roller is rotating. This results in a dynamic adjustability.

Depending on the embodiment of the transport arrangement, the outside diameter is adjusted pneumatically, hydraulically, mechanically or piezoelectrically or in combination of two or more of these. The pneumatic, hydraulic and piezoelectric driving modes are suitable for dynamic adjustments; however, they are expensive and complex. The mechanical driving mode is cost-favorable; however, it is rather more suitable for the calibration of the transport rollers before the printing machine is operated.

### BRIEF DESCRIPTION OF THE DRAWINGS

FIG. 1 shows a schematic side view of a printing machine, said printing machine comprising one embodiment of a transport arrangement for printing materials.

FIG. 2 shows a schematic side view of another embodiment of a transport arrangement for printing materials, said transport arrangement is usable in the printing machine.

FIG. 3 shows a schematic of an exemplary embodiment of a transport roller that is used in the transport arrangement.

FIG. 4 shows a schematic of an alternative exemplary embodiment of a transport roller that is used in the transport arrangement.

FIG. 5 shows a schematic of another alternative exemplary embodiment of a transport roller that is used in the transport arrangement of FIG. 1 or 2; and

FIG. 6 shows a schematic, partially in section, of another exemplary embodiment of a transport roller that is used in the transport arrangement of FIG. 1 or 2.

### DETAILED DESCRIPTION OF THE INVENTION

The invention, as well as additional details and advantages of said invention, will be explained hereinafter with the use of preferred exemplary embodiments and with reference to the figures.

It should be noted that the terms top, bottom, right and left, as well as similar expressions, used in the description hereinafter relate to the orientations or arrangements depicted in the figures and are only used to describe the exemplary embodiments. However, these expressions are not to be understood to have a restrictive meaning.

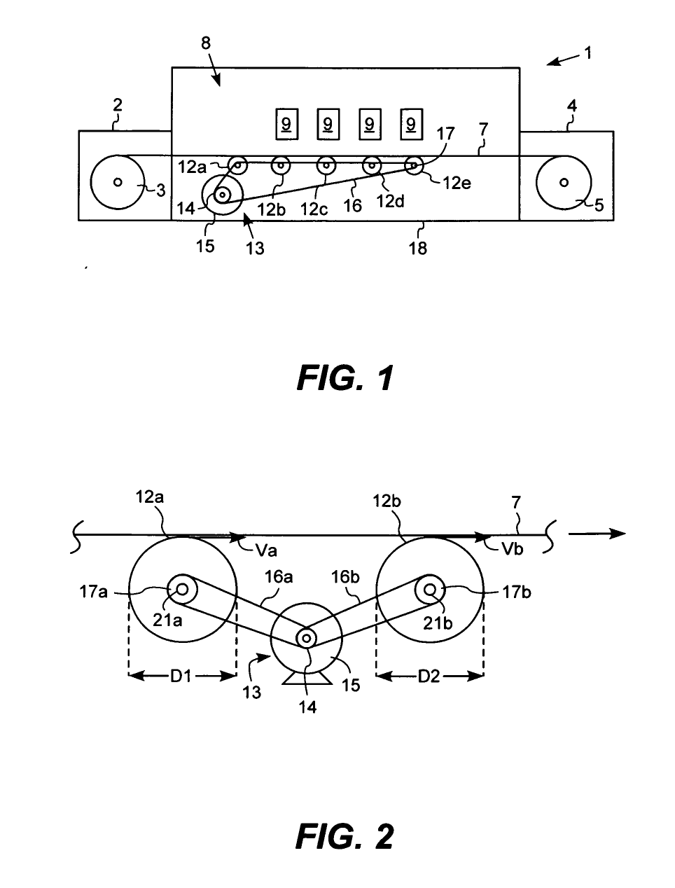

FIG. 1 is a schematic side view of a printing machine 1, this is an example of a processing machine. The printing machine 1 includes a feeder unit 2 with a first printing material roll 3 and a delivery unit 4 with a second printing material roll 5. A printing material web 7 moves along a transport path from the first printing material roll 3 to the second printing material roll 5. Between the feeder unit 2 and the delivery unit 4 and along the transport path of the printing material web 7, there is a printing section 8 wherein several printing stations 9 for different colors are arranged. The printing material web 7 is also guided in the printing machine 1 over at least one transport roller 12. Furthermore, the printing machine 1 includes a driving unit 13 with a driving roller 14, said driving roller are intended for conveying the printing material web 7 from the first printing material roll 3 in the direction to the second printing material roll 5.

The driving unit 13 includes a driving disk 14, a driving motor 15 as well as a driving belt 16. The driving belt 16 extends around the driving disk 14 and is in a driving relationship with the transport roller disks 17 on the transport rollers 12. The driving unit 13 is connected to a frame 18 of the printing machine 1.

During operation, the driving motor 15 is supplied with power and rotates the driving disk 14. The driving disk 14 drives the transport roller disks 17 via the driving belt 16 and, thus, also drives the plurality of the transport rollers 12 (here five transport rollers 12a, 12b, 12c, 12d, 12e). Hereinafter, the transport rollers will generally be identified by reference number 12, wherein an added letter identifies any specific transport roller, respectively.

FIG. 2 shows an embodiment of a transport arrangement 20 for printing materials, said transport arrangement comprising two transport rollers 12a, 12b and one main drive 13. The main drive 13 and the transport rollers 12a and 12b are mounted to a frame 18 of a printing machine 1. The transport rollers 12a and 12b are arranged so as to transport a printing material web 7. In order to ensure a uniform transport of the printing material web 7 the transport speed Va imparted by the left transport roller 12a should be equal to the transport speed Vb imparted by the transport roller 12b. The transport speed V of a transport roller 12 is a function of its outside diameter and its input rate of revolutions. The input rate of revolutions of a transport roller 12 is determined by the rate of revolutions of the main driving motor 15 as well as by the diameter of the main driving disk 14 and the transport roller disk 17 of the respective transport rollers 12.

Relative differences of the transport speeds Va, Vb of the two transport rollers 12a, 12b can occur, in particular, due to differences in the dimensions of the main driving disk 14, the transport roller disks 17a, 17b, and the transport rollers 12a, 12b. Fluctuations of the rate of the input rate of revolutions of the main driving motor 15, of course, are in most cases not desirable; however, they do not have the effect that an existing (and sometimes even desired) difference of the transport speeds Va, Vb will be changed. This is because changes of the input rate of revolutions of the main driving motor 15 lead to uniform changes of the transport speed Va as well as of the transport speed Vb.

In one case, the operator of the printing machine 1 can request for the transport speeds Va and Vb to be exactly the same. In another case, the operator of the printing machine can request for the transport speeds Va and Vb to be at a fixed ratio with respect to each other. For example, the transport speed Vb is by 20% greater than the transport speed Va. This might be the case when, instead of a continuous printing material web 7, a printing material is transported that is fed in form of sheets by the feeder unit 2 of the printing machine 1. It is, thus, possible to accelerate a sheet that is located above the second transport roller 12b and is conveyed at the greater transport speed Vb. In this manner, a greater distance between successive sheets is achieved.

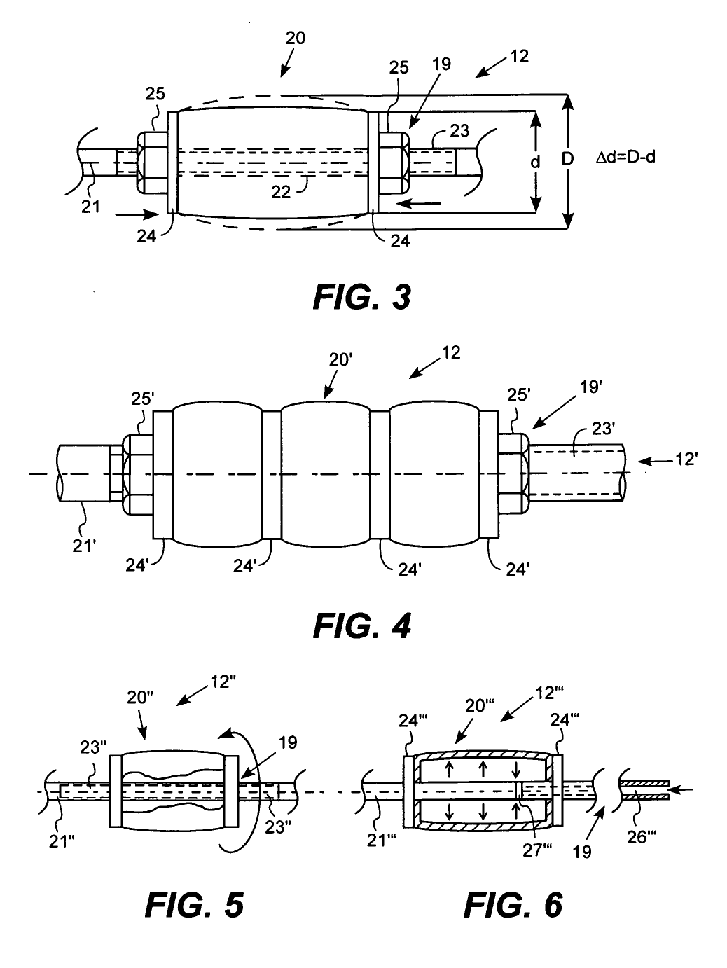

At least one of the transport rollers 12 has an actuating arrangement 19 for adjusting the outside diameter of this transport roller 12. FIGS. 3, 4, 5 and 6 show different embodiments of a transport roller 12 as well as an associated actuating arrangement 19 for adjusting its outside diameter. Hereinafter, FIGS. 3 through 6 show different embodiments of transport rollers 12 and an actuating arrangement 19 that will now be described. To the extent that this is possible, the same reference signs are used for different embodiments, provided these are similar regarding design and function. The reference signs used in FIG. 3 will be characterized by special character (′) in FIG. 4, by special character (″) in FIG. 5, and by special character (′″) in FIG. 6.

FIG. 3 shows an exemplary embodiment of a transport roller 12 comprising a roller body 20 and a shaft 21, said roller body 20 is mounted on said shaft 21. The shaft 21 extends transversely to the transport direction of the printing material web 7 and is supported so as to be rotatable relative to the frame 18 of the printing machine 1. Also, the transport roller disk 17 is attached to the shaft 21, however, transport roller disk 12 is not shown in the view of FIG. 3.

The roller body 20 is cylindrical and consists of an elastic material, for example, of rubber or of a foam material. The roller body 20 has a bore 22 that is indicated in dashed lines in FIG. 3, said bore 22 extending along the rotational axis of the roller body 20. The shaft 21 extends through the bore 22 and has a thread 23 in the region of the bore 22. To the right and to the left of the roller body 20, a disk 24 each is arranged. The disks 24 also have a not specifically shown central bore through which extends the shaft 21, said shaft is fitted in a manner so as to have play. To the right and to the left of the disks 24 are the nuts 25, these representing the fitting arrangement 19 that are screwed on the thread 23 of the shaft 21. Alternatively, it is also possible to provide a nut 25 on only one side of the roller body 20, in which case the shaft 21 is provided with a shoulder on the opposite side.

Depending on the distance of the nuts 25 and the adjacent disks 24, a more or less strong axial force is exerted on the roller body 20. If the distance of the nuts 25 and the cams 24 corresponds to the length of the roller body 20, said roller body is not compressed and no axial force is applied to the roller body 20. The outside diameter of the roller body 20 in relaxed state corresponds to the diameter d shown in FIG. 3.

As soon as one of the nuts 25 is screwed toward the other nut 25, the disks 24 are moved toward each other, and the interposed roller body 20 is subjected to an axial force. This application of an axial force causes the roller body to be compressed lengthwise, as a result of which the compressed material of the roller body bulges outward. The roller body 20 becomes barrel-shaped and assumes a larger outside diameter D. The closer the nuts 25 are screwed toward each other, the smaller is the axial length of the roller body 20 and the larger becomes the curvature of the roller body 20 and thus the outside diameter of said roller body.

FIG. 4 shows another exemplary embodiment of a transport roller 12′, said roller having a similar design as the transport roller 12 of FIG. 3. Therefore, the description will be slightly abbreviated. The transport roller 12′ has a roller body 20′ and a shaft 21′. A bore 22′ extends through the roller body 20′. The shaft 21′ of the transport roller 12′ has a thread 23′ which is in engagement with two nuts 25′, the latter is the actuating arrangement 19′. Several disks 24′ are arranged between the nuts 25′. The roller body 20′ of the transport roller 12′ is divided into three parts, with a disk 24′ arranged between each of the three parts and also to the right and to the left of said three parts.

As described above regarding the transport roller 12 of FIG. 3, the outside diameter of the three-part roller body 20 changes as a function of the distance of the nuts 25′. The smaller the distance of the nuts 25′ is, the more the three-part roller body 20′ is compressed. As a result, the three parts of the roller body 20′ take on a barrel form as is obvious from FIG. 1 and as is indicated in FIG. 3. The outside diameter of the roller body 20′ varies between a diameter d in relaxed state and a diameter D in screwed-together state.

FIG. 5 shows another exemplary embodiment of a transport roller 12″. The transport roller 12″ has a roller body 20″ as well as a shaft 21″. A bore 22″ extends through the roller body 20″. A thread 23″ is provided on the shaft 21″. The thread 23″ may be a single thread, or may consist of two threaded regions. The two threaded regions may have the same or different thread orientations, i.e., they may be right-hand or left-hand threads or both. Also, in the embodiment of the transport roller 12″ of FIG. 5, there is a disk 24″ each provided to the right and to the left of the roller body 20″. In the embodiment of FIG. 5, the disks 24″ do not have a passage hole but they have an internal thread on their inside bore 22″. The internal thread of the disk 24″ is in engagement with the external thread 23″ of the shaft 21″, and these threads together form the actuating arrangement 19″. In this manner, the nuts 25, 25′ of the previously described embodiments is omitted. By screwing the disks 24″ toward each other and away from each other the roller body 20″ of the transport roller 12″ is compressed more or less in axial direction. As in the aforementioned exemplary embodiments, the roller body 20″ adopts a barrel form as the disks 24″ are screwed closer toward each other. The outside diameter of the roller body 20″ thus becomes larger or smaller as a function of the distance of the disks 24″.

FIG. 6 shows another exemplary embodiment of a transport roller 12′″. The transport roller 12′″ has a roller body 20′″ as well as a shaft 21′″. Disks 24′″ are arranged to the right and to the left of the roller body 20′″. The disks 24′″ are rigidly connected with the shaft 21′″. The shaft 21′″ has an axially extending longitudinal bore 26′″, a sectional view of which is seen on the right side of FIG. 6. The longitudinal bore 26′″ extends from the right end of the shaft 21′″ up to the region of the roller body 20′″. In the region of the roller body 20′″, the shaft 21′″ has a transverse bore 27′″ that opens toward an interior space formed by the roller body 20′″. The longitudinal bore 26′″ extends at least up to the transverse bore 27′″, so that a flow agent communication is established between these bores.

In the exemplary embodiment of FIG. 6, the roller body 30′″ is cylindrical and has an outside diameter that approximately corresponds to the outside diameter of the disks 24′″. The roller body 20′″ is approximately U-shaped in cross-section and consists of an elastic material such as, for example, rubber. The roller body 20′″ is impermeable to the flow agent and is connected with the disks 24′″ so as to be tight with respect to the flow agent.

The transport roller 12′″ of FIG. 6 can also be adjusted regarding its outside diameter in that the outside diameter of the roller body 20′″ is changed. The longitudinal bore 26′″ communicates with a (not illustrated) source of a pressurized flow agent, for example, a pressurized air source or a hydraulic pressure source. Depending on the supply pressure of the flow agent source, the pressurized flow agent is guided through the longitudinal bore 26′″ and the transverse bore 27′″ into the inside of the roller body 20′″. The flow agent distributes itself on the inside of the roller body 20′″ and exerts a radially outward-directed force on the roller body 20′″. As a result of this, the outside diameter of the roller body 20′″ is changed. Thus, the source of pressurized flow agent, the longitudinal bore 26′″ and the transverse bore 27′″ form the actuating arrangement 19′″ in the exemplary embodiment of FIG. 6. The outside diameter of the roller body 20′″ can vary between a small diameter d in relaxed state without the application of a pressurized flow agent and a large diameter D in a state with the application of pressure.

In the transport arrangements of FIGS. 1 and 2, it is possible to use one or more transport rollers 12, 12′, 12″ or 12′″. As will be obvious to the person skilled in the art, it is possible to adjust a different outside diameter of the transport rollers 12, 12′, 12″, 12′″, depending of the design of the transport rollers 12, 12′, 12″, 12′″. With the same input rate of revolutions, it is possible to vary the transport speed Va or Vb provided by the transport roller 12.

For example, supposing a case in which the transport speed Vb of the right transport roller 12b is smaller by 5% than the transport speed Va of the left transport roller 12a. This difference results from the fact that the outside diameters of the transport rollers 12a and 12b, as well as the outside diameters of the transport roller disks 17a, 17b of the left and right transport rollers 12a and 12b are different due to manufacturing tolerances.

At least one of the transport rollers 12a, 12b of the transport arrangement of FIG. 2 is adjustable with respect to its outside diameter and has a design as shown in FIGS. 3 through 6. Regarding the aforementioned example, it is assumed that at least the transport roller 12b has a design as in FIGS. 3 through 6.

For calibrating the transport arrangement of FIG. 2, the outside diameter of the transport roller 12b is enlarged by way of the respective actuating arrangement 19 until the difference of 5% of the two transport speeds Va and Vb has been equalized for. To accomplish this, the distance of the disks 24, 24′, 24″ is varied (FIGS. 3, 4 and 5) by screw action, or the outside diameter of the roller body 20′″ is enlarged by injection of a pressurized flow agent (FIG. 6).

The ratio of the transport speeds Va and Vb is adjusted by changing the outside diameter of the roller body 20, 20′, 20″, 20′″ not only to a ratio of 1 (equalization of the difference of 5%). The outside diameter of the transport roller 12 is enlarged further, so that the transport speed Vb is, for example, 1.2 times the transport speed Va.

The transport arrangement for printing materials is adjusted or calibrated or both before the printing machine 1 is operated, for example in a factory before delivery of the printing machine. In such cases, the adjustment of the transport rollers 12 is suitably accomplished with the simply designed exemplary embodiments of the transport rollers 12 of FIGS. 3, 4 and 5 because said transport rollers is made in a cost-effective manner. Alternatively, it is possible to perform a dynamic adjustment of the outside diameters of the transport rollers 12 during the operation of the printing machine. For this, the embodiment of FIG. 6 would be suitable, for example

So far the description has been of a pneumatic, hydraulic or mechanical adjustment of the outside diameter or of a combination of two or more of these. A piezoelectric drive represents another suitable driving mode for the dynamic adjustment of the outside diameter of the transport rollers 12. A piezoelectric driving element is interposed, for example, between one of the nuts 25, 25′ or a shoulder of the shaft 21, 21′, 21″, and the roller body 20, 20′, 20″ and can apply an axial force. When this happens, the piezoelectric driving element would exert an axial force on the roller body 20 and push said roller body into a more or less barrel-shaped configuration. As a result of this, a smaller diameter or a correspondingly larger diameter of the roller body 20 is attained. The actuation with the piezoelectric element or with the pressurized flow agent is also suitable for dynamic adjustment processes during the operation of the printing machine.

A further option is to first achieve a basic calibration of the outside diameter of at least one of the transport rollers with the use of the mechanical actuating arrangement 19, for example by way of a screw adjustment as shown in FIGS. 3, 4 and 5. Subsequently, a dynamic adjustment of the outside diameter during operation of the printing machine 1 is used, for example in order to equalize fluctuations of the input rate of revolutions. The dynamic adjustment is achieved with the use of a piezo element to exert an axial force, said piezo element is provided on the transport rollers 12, 12′ of FIGS. 3 and 4 instead of a disk 24, 24′ or in addition to these disks. Furthermore, a dynamic adjustment is achieved by way of pressurized flow agents (FIG. 6).

The invention has been described with reference to preferred exemplary embodiments, whereby the individual features of the described exemplary embodiments are freely combined or interchanged with each other or both, provided they are compatible. Likewise, the individual features of the described exemplary embodiments are omitted. Numerous modifications and designs will be possible for and obvious to the person skilled in the art, without departing from the invention as a result of this.

What is claimed is:

1. A transport arrangement for printing materials in a printing machine, said transport arrangement comprising:
one rotatably supported first transport roller with a first shaft and a roller body having a first outside diameter;
at least one rotatably supported second transport roller with a second shaft and a roller body having a second outside diameter, said second transport roller is arranged downstream of the first transport roller and
an actuating arrangement for the adjustment of the outside diameter of at least one of the first or the second transport rollers in such a manner that the outside diameters of the first or of the second transport rollers or both are at a fixed ratio relative to each other.

2. The transport arrangement as in claim 1, wherein the fixed ratio is equal to 1.

3. The transport arrangement as in claim 1 wherein the ratio is fixed before the printing machine is operated.

4. The transport arrangement as in claim 1 wherein the actuating arrangement is actuated while at least one of the transport rollers is rotating.

5. The transport arrangement as in claim 1, wherein the transport rollers are driven by a common driving motor.

6. The transport arrangement as in claim 1, wherein the actuating arrangement are pneumatically, hydraulically, mechanically and/or piezoelectrically driven.

7. A printing machine comprising at least one printing unit and at least one transport arrangement.

8. A method for calibrating a transport arrangement for printing materials in a printing machine comprising one first transport roller having a first outside diameter and at least one second transport roller having a second outside diameter, said method comprising the step of adjusting the outside diameter of at least one of the second transport rollers to a dimension that is at a fixed ratio relative to the outside diameter of the first transport roller.

9. The method of claim 8, wherein the fixed ratio is equal to 1.

10. The method of claim 8 wherein the ratio is fixed before the printing machine is operated.

11. The method of claim 8 wherein the ratio is fixed while at least one transport roller is rotating.

12. The method as in claim 8 wherein the outside diameter is adjusted pneumatically, hydraulically, mechanically or piezoelectrically or in a combination of two or more of these.
